(19) United States
(12) Patent Application Publication
(10) Pub. No.: US 2011/0293367 A1
(43) Pub. Date: Dec. 1, 2011

(54) Roadway Marking Devices and Methods of Using Thereof

(76) Inventors: Arra David Yeghiayan, Windham, NH (US); Michael Collins, Bedford, NH (US)

(21) Appl. No.: 13/205,979

(22) Filed: Aug. 9, 2011

Related U.S. Application Data
(63) Continuation-in-part of application No. 12/626,113, filed on Nov. 25, 2009.
(60) Provisional application No. 61/201,290, filed on Dec. 9, 2008.

(51) Int. Cl. E01F 9/012; G09F 3/00; E01F 9/015

(52) U.S. Cl. 404/10; 40/299.01; 404/72

(57) ABSTRACT

A marking device includes a support having a first end engaged with a ground surface, and a second end positioned away from the ground surface. A force transfer structure is connected to the second end of the support, wherein the force transfer structure has a diameter less than a diameter of a middle portion of the support. A cylindrical biasing mechanism attached to the middle portion of the support, wherein the cylindrical biasing mechanism has a first end, a second end and a middle portion, wherein the middle portion has a diameter that exceeds a diameter of the first end and the second end. An elongated rod, attached to the second end of the cylindrical biasing mechanism at a first end.

### CROSS-REFERENCE TO RELATED APPLICATION

This application claims priority to copending U.S. Application having Ser. No. 12/626,113 entitled, “Method and Apparatus for a Roadway Marker, filed Nov. 25, 2009, which claims priority to U.S. Provisional Application entitled, “METHOD AND APPARATUS FOR A NOVEL ROADWAY MARKER,” having Ser. No. 61/201,290 filed Dec. 9, 2008, which are entirely incorporated herein by reference.

### FIELD OF THE DISCLOSURE

The present disclosure is generally related to marking devices and more particularly is related to roadway marking devices and methods of using thereof.

### BACKGROUND OF THE DISCLOSURE

Roadway markers are primarily defined by a vertical plastic or fiberglass element rising three or more feet from the ground and having a reflective element. The marker is planted in the ground so that the reflective element generally is easily seen. The markers may be used to mark driveway entrances and turning roadways that may be otherwise difficult for drivers, snow plow operators, and others to see, which may protect property, such as a lawn, plants or mailboxes from damage. A problem with these markers is that they need to be mounted close to the road, which inevitably results in getting hit by passing vehicles, snow from snowplows, or the like, damaging the vehicle and the marker and/or dislodging the marker. Damage to the marker generally results in the marker getting bent or broken, such that the marker is ineffective and needs to be replaced.

Markers defined by a vertical plastic or fiberglass element may also be tough to install in rocky, frozen, or otherwise hard to penetrate ground since they are not constructed from materials strong enough to penetrate a hard or dense surface. Additionally, A marker of three or more feet may also be difficult to forcefully install the marker into the ground because the length of the marker cannot withstand the force of a pounding hammer. Additionally, many markers are designed for a unitary purpose and include features that lend to success only within a certain field of use of the marker. Currently available markers are unable to be adapted to variances in use of a marker, such as variances dictated by usefulness, efficiency, time, societal considerations and aesthetic purposes.

Thus, heretofore unaddressed needs exists in the industry to address the aforementioned deficiencies and inadequacies.

### SUMMARY OF THE DISCLOSURE

Embodiments of the present disclosure provide a system and method for providing a roadway marker. Briefly described, in architecture, one embodiment of the system, among others, can be implemented as follows. A support has a first end engaged with a ground surface, and a second end positioned away from the ground surface. A force transfer structure is connected to the second end of the support, wherein the force transfer structure has a diameter less than a diameter of a middle portion of the support. A cylindrical biasing mechanism is attached to the middle portion of the support, wherein the cylindrical biasing mechanism has a first end, a second end and a middle portion, wherein the middle portion has a diameter that exceeds a diameter of the first end and the second end. An elongated rod, attached to the second end of the biasing mechanism at a first end.

The present disclosure can also be viewed as providing a method of securing a roadway marker. In this regard, one embodiment of such a method, among others, can be broadly summarized by the following steps: attaching a spring element, at a first side, to a middle portion of a support, wherein the middle portion of the support is located between a first end and a second end of the support; attaching an elongated rod to a second side of the spring element; and securing the support to a stationary structure.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a cross-sectional side view of a roadway marker, in accordance with a first exemplary embodiment of the disclosure.

FIG. 2 is a side view of a support of the roadway marker, in accordance with the first exemplary embodiment of the disclosure.

FIG. 3 is a cross-sectional side view of a spring element of the roadway marker, in accordance with the first exemplary embodiment of the disclosure.

FIG. 4 is a cross-sectional side view of a roadway marker, in accordance with the first exemplary embodiment of the disclosure.

FIG. 5 is a cross-sectional side view of a spring element of a roadway marker, in accordance with a second exemplary embodiment of the disclosure.

FIG. 6 is a cross-sectional side view of a roadway marker, in accordance with a third exemplary embodiment of the disclosure.

FIG. 7 is a plan view of the roadway marker, in accordance with the third exemplary embodiment of the disclosure.

FIG. 8 is an illustration of a flowchart illustrating a method of securing a roadway marker, in accordance with a fourth exemplary embodiment of the present disclosure.

### DETAILED DESCRIPTION

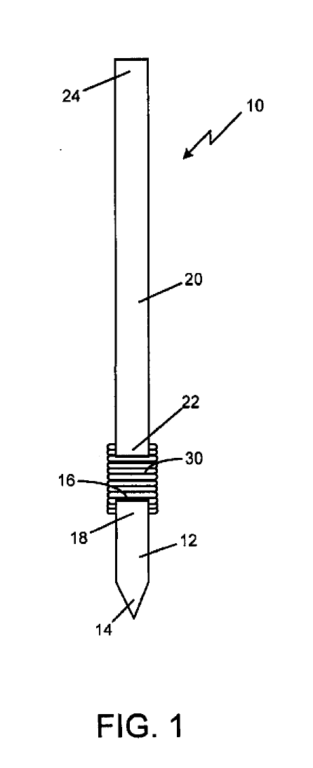

FIG. 1 is a cross-sectional side view of a roadway marker 10, in accordance with a first exemplary embodiment of the disclosure. The roadway marker 10 includes a support 12. The support 12 has a first end 14 that is engaged or engagable with a ground surface and a second end that is facing away from the ground surface. A middle portion 18 located between the first end 14 and the second end 16. An elongated rod 20, having a first end 22 and a second end 24, is attached at the first end 22 of the elongated rod 20 to the middle portion 18 of the support 12 with a spring element 30.

The support 12 of the roadway marker 10 may be secured in a stationary position, such as in the ground, a ground surface, or in a fixturing unit, with the spring element 30 and the elongated rod 20 rising above the support 12. In this arrangement, the support 12, the elongated rod 20 and the spring element 30 may be substantially axially aligned. However, when the support 12 secured at an angle to the horizon the roadway marker 10 may experience deflections due to external forces, such as gravity and may cause the second end 24 of the elongated rod 20 to droop slightly, depending on the rigidity and material composition of the elongated rod 20 and the spring element 30.

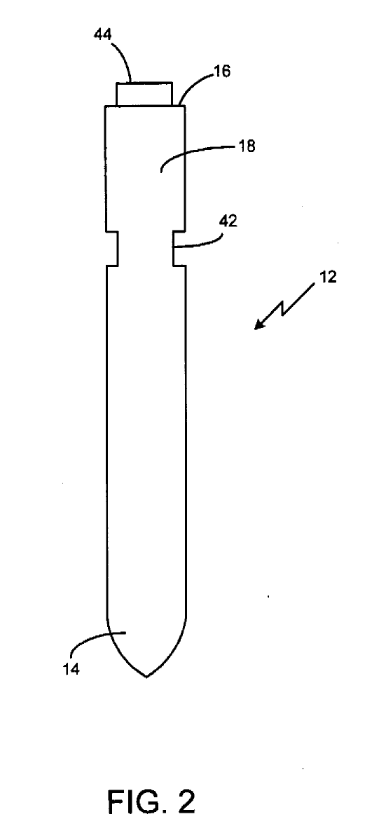

FIG. 2 is a side view of a support 12 of the roadway marker 10, in accordance with the first exemplary embodiment of the disclosure. The support 12 may be constructed from a hard material, such as hardened steel or a hardened metallic compound. The support 12 may also be constructed from any other organic, synthetic or compound material that is hard enough to support the roadway marker 10, such as plastic or wood. The composition of the support 12 may vary depending on the intended use of the roadway marker 10. For example, a support 12 to be secured in frozen or rocky ground may be constructed from strong materials, such as hardened steel. Additionally, the support 12 may need to withstand the forces associated with securing, such as a driving force or hammering from a tool or device. The first end 14 of the support 12 may include a tapered or sharpened design, as depicted in FIG. 1, to allow the support 12 to be secured in a stationary position by force, such as driven into the ground, or other fixturing surface. The support 12 may also include plating on an exterior surface to resist corrosion due to ambient elements, such as resisting rust.

The support 12 may be generally characterized as a rigid shaft having a cylindrical cross-section, but may include a cross-section that is any other shape, such as square and/or rectangular, and may include a threaded or corkscrew exterior. The length and diameter (width, if not cylindrical) of the support 12 may be selected to correspond to the intended use of the roadway marker 10, and/or the size of the spring element 30 and/or the elongated rod 20. For example, the support 12 may be approximately ⅜ of an inch in diameter and 8 inches in length if used with an elongated rod 20 of approximately 48 inches in length. Other lengths and diameters of the support 12 may be used depending on the conditions surrounding the use of the roadway marker 10, which may include conditions relating to ambient temperatures, securing methods and/or effect on a surrounding environment.

With references to FIGS. 1-2, the support 12 includes a first end 14, a second end 16 and a middle portion 18. The support 12 may further include a collar groove 42 and an installation pad 44. The collar groove 42 may be a groove located around all or a material portion of the circumference of the support 12, and may be used to facilitate removal of the support 12 from a secured position, such as from the ground. The collar groove 42 may also be a protruding collar that is used to facilitate removal of the support 12. Removal of the support 12 may be accomplished with an external tool, such as a pry bar using leverage. For example, a tool such as a pry bar may be used to leverage the support 12 from a position where it is engaged with a ground surface. The pry bar may include an angled structure and a contact surface, where the contact surface is positioned to contact the collar groove 42 while the angled structure contacts the ground surface. In this configuration, a user may initiate a force on the pry bar, which is transferred through the angled structure and into the contact surface, thereby forcing the support 12 away from the ground surface.

The installation pad 44 is characterized as a driving structure or force transfer structure, which is capable of bearing the force necessary to install the support 12 into a stationary position. The installation pad 44 may be constructed of a hardened material, such as hardened steel, and may be attached to the second end 16 of the support 12 with a fastener, threaded fastener, adhesive or any other means of creating an attachment. The installation pad 44 may be attached to the end of the support 12 such that it is positioned within an interior portion of the spring element 30 when the roadway marker 10 is in use. The installation pad 44 may be removably attached. When installing the support 12 into a secured position, such as the ground, a hammer may be used to drive the support 12 into position. Due to the hardness of the securing surface, repeated blows may be needed with the hammer. Accordingly, as the installation pad 44 transfers the force of the hammer blows to the support 12, the installation pad 44 may become deformed. The deformation will not interfere with the support sliding into the spring element 30 until the deformation extends the installation pad 44 beyond a width of the middle portion 18 of the support 12.

The first end 14, second end 16 and middle portion 18 of the support 12 may be characterized as distinct portions of the support 12. The first end 14 may be characterized as the portion of the support 12 that is proximate to the ground or fixturing unit when in a secured position. For example, with respect to FIG. 2, the first end 14 may be the portion of the support 12 from the tip (i.e., the sharpened end situated to be secured into the ground) to the portion of the collar groove 42 closest to the tip. The second end 16 may be characterized as the portion of the support 12 that is furthest from the first end 14, and used to secure the support 12 in a secured position. For example, with respect to FIG. 2, the second end 16 may be the portion of the support 12 having the installation pad 44 and/or directly abutting the installation pad 44. The middle portion 18 may be characterized as the portion of the support 12 from the portion of the collar groove 42 closest to the tip to the portion of the support 12 directly abutting the installation pad 44.

The elongated rod 20 is characterized as a shaft with a cylindrical cross-section having a length that is substantially greater than a diameter. The diameter of the elongated rod 20 may be any size and may be proportional to the length of the elongated rod 20. For example, an approximate diameter of 0.25 inches may be used with an elongated rod 20 having a length of approximately 48 inches. The elongated rod 20 may also be non-cylindrical in cross-section, such as rectangular or triangular and have a cross-sectional size that varies. The length of the elongated rod 20 may include any size such that it is great enough to mark the edge of a roadway, depending on the desired use. For example, the elongated rod 20 may have a length of 48 inches if the desired use of the roadway marker 10 is in weather conditions where a snowfall is anticipated. Alternatively, a length greater than 48 inches may be required in extreme winter conditions, due to extensive snowfall, or with use in a farming setting, such as with marking the roadway proximate to a field having a crop that grows tall. A length smaller than 48 inches may also be used in other settings, such as in climates where some, but not a substantial amount of snowfall is anticipated. The elongated rod 20 may be substantially rigid, or be able to flex or bend, depending on the materials it is constructed from. Additionally, the elongated rod 20 may include varying shapes, such as bent shapes, “Z” shapes, “S” shapes, or other arc shapes.

The elongated rod 20 may include other features such as a colored exterior to enhance visibility of the roadway marker 10. For example, PMS color DS 18-1 C1, generally designated as orange, may be used if the roadway marker 10 is used in a setting involving snow or other winter conditions. Any additional colors, such as yellow, fluorescent green, or combination of colors, such as stripes or contrasting designs, that may enhance visibility may be used and are considered within the scope of the present disclosure. Additionally, the elongated rod 20 may include an exterior surface, or a portion of an exterior surface that comprises a reflective material to further enhance visibility of the roadway marker 10. Although reflective material may be used under any conditions, it may be specifically beneficial when the roadway marker 10 is used in conditions with low lighting, such as at night.

The elongated rod 20 may further include a structure or object located proximate to the second end 24 of the elongated rod 20. For example, an ornamental flag or a cautionary symbol, such as a flashing light or reflective ornament, may be affixed to the second end 24 of the elongated rod 20. Additionally, the structure or object located proximate to the second end 24 of the elongated rod 20 may include printed material, such as cardboard structure or object having an image or text printed thereon. The structure or object may be permanently, semi-permanently or removably affixed to the elongated rod 20 by any means commonly known to those in the art. In one example, a flag constructed from fabric may include a loop portion capable of receiving the second end 24 of the elongated rod 20. In another example, a reflective element may be affixed to the second end 24 of the elongated rod 20. In another example, the structure or object may have an integral mechanical attachment, such that the structure or object is removably affixed to the elongated rod 20. In accordance with this design, the integral mechanical attachment is not a separate element or structure, but rather an integral part of either the structure or object or the elongated rod 20. Additionally, the integral mechanical attachment may not require any fasteners or attachment mechanisms, such as screws or bolts.

In one of many alternative arrangements, a cap (not shown) may be affixed to the second end 24 of the elongated rod 20 of the elongated rod 20. The cap may restrain a structure or object, such as a flag, on the second end 24, or the cap may be used to seal the elongated rod 20. The cap may be constructed from vinyl, rubber, plastic or any UV resistant material. The cap may also have an exterior surface or portion of an exterior surface with any color or reflective coating. Additionally, the cap may be permanently, semi-permanently or removably attached to the elongated rod 20, which may be accomplished by bonding, gluing, fastening, or press or friction fitting the cap to the elongated rod 20. The cap may be secured such that it would remain affixed to the elongated rod 20 under normal operating conditions associated with the roadway marker 10.

The spring element 30 is characterized as a substantially cylindrical spring, structure, or combination of structures that has potential energy. Commonly, the spring element 30 may be referred to as a barrel, antenna or coiled spring. The spring element 30 may be constructed from stainless steel wire, such as the 300 series alloy, or any other metal, metallic compound, or synthetic material, that is capable of being formed into a spring structure. The spring element 30 may include a size and shape that is proportional to the elongated rod 20 and the support 12, and may also include further design characteristics depending on the intended use, such as strength and/or flexibility. The spring element 30 may have strength and flexibility characteristics that allow it to retain the elongated rod 20 in a substantially vertical position during use without impact, but may be biased to a non-vertical position upon impact of a structure, such a vehicle or snowplow. In one example, the spring element 30 is constructed from 0.110-inch diameter wire. The spring element 30 may include a weather-protection coating, such as galvanization or rubber.

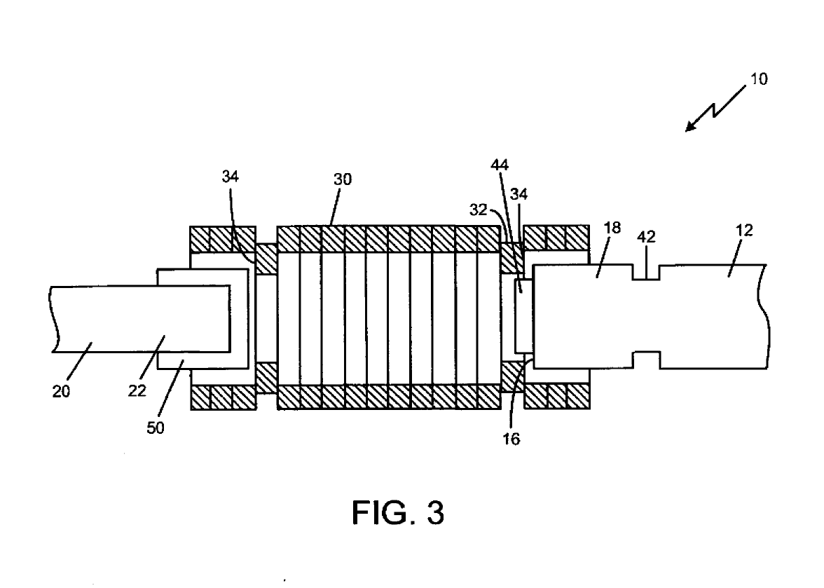

FIG. 3 is a cross-sectional side view of a spring element 30 of the roadway marker 10, in accordance with the first exemplary embodiment of the disclosure. The spring element 30 may be a substantially cylindrical barrel spring, and may include design features or variations, depending on the desired use with in the roadway marker 10. The spring element 30 may have an inner diameter and may have one or more reduced inner diameters at the portion of the spring element 30 that contacts the elongated rod 20 and/or the support 12. The inner diameter may be measured between the inner walls of the spring element 30 along a cross-sectional cut taken perpendicular to an axis along the length of the spring element 30. The spring element 30 may have an inner diameter that varies dependent on intended use, environmental conditions, the size of the support 12 and the size of the elongated rod 20. In one example, the inner diameter of the spring element 30 is approximately 1 inch for an elongated rod 20 having a length of approximately 48 inches.

The reduced inner diameter of the spring element 30 may be characterized as a portion of the spring element 30 having a small inner diameter with respect to the inner diameter between the inner walls of the spring element 30. The reduced inner diameter may be achieved through various designs, structures and configurations. For example, the reduced inner diameter may be a small-diameter coil 32 within the spring element 30. The small-diameter coil 32 may protrude towards the inner portion of the spring element 30 thereby creating a face 34 that acts as a structural stop to contact another structure within the spring element 30, such as the elongated rod 20 or the support 12. The reduced inner diameter may prevent the elongated rod 20 or support 12 from being inserted too far within the spring element 30. In one example, the reduced inner diameter of the spring element 30 may be located approximately ⅞ inch from the end points of the spring element 30. The reduced inner diameter of the spring element 30 may correspond to the diameter of the first end 22 of the elongated rod 20 and/or the second end 16 of the support 12, such that the spring element 30 may be connected to either the support 12 and/or the elongated rod 20, and may include variations in location, size and design.

A connection between the spring element 30 and the elongated rod 20 and/or support 12 may be achieved by a variety of designs or configurations. The connection may be formed from a bonding material, snap-fit connection, press-fit connection, and/or a removable, permanent or semi-permanent fastener between the spring element 30 and the elongated rod 20 and/or support 12. Additionally, the roadway marker 10 may include a bushing 50 between the spring element 30 and the first end 22 of the elongated rod 20. The bushing 50 may compensate for a diametral difference between the inner diameter of the spring element 30 and the outer diameter of the elongated rod 20. The bushing 50 may be attached to the elongated rod 20 in a secured manner, such as, for example, press-fit onto the first end 22 of the elongated rod 20. The bushing 50 may be constructed from a variety of materials, including, but not limited to plastics, metallic compounds and synthetic compositions. In one example, the bushing 50 is constructed from UV-resistant Polyoxymethylene, more commonly known as DELRIN®. As depicted in FIG. 3, the bushing 50 may contact the face 34 of the small-diameter coil 32. Additionally, a bushing 50 may be included as a connection design with other parts of the roadway marker 10. Although a bushing 50 may be used, a connection between the spring element 30 and another structure may not require a bushing 50 to form a connection.

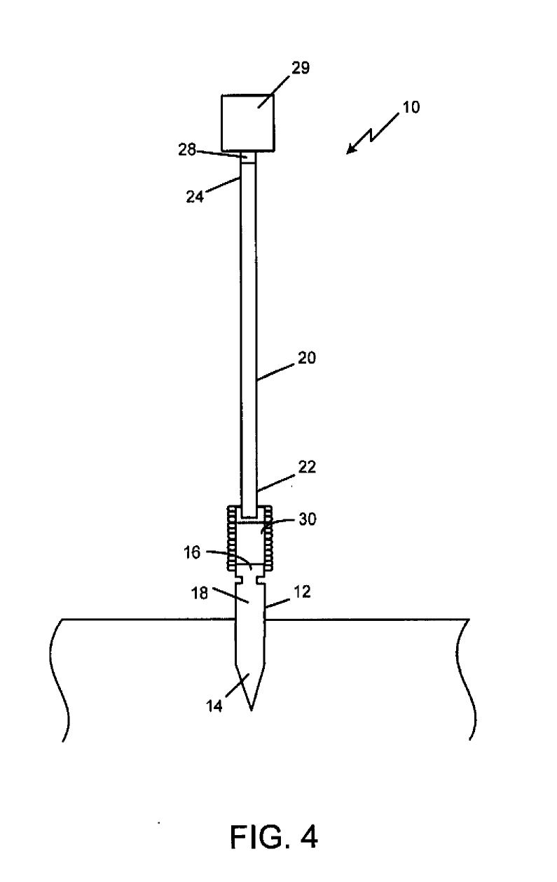

FIG. 4 is a cross-sectional side view of a roadway marker 10, in accordance with the first exemplary embodiment of the disclosure. The roadway marker 10 may further include an object 29 located proximate to the second end 24 of the elongated rod 20. The object 29 may include any structure, such as an ornamental flag, a cautionary symbol, a flashing light or reflective ornament. Additionally, a portion of the object 29 may include printed material, such as cardboard sign having written textual information or an image printed thereon. The object 29 may have an integral mechanical attachment 28, such that the object 29 is removably affixed to the elongated rod 20. In accordance with this design, the integral mechanical attachment 28 is not a separate element or structure, but rather an integral part of either the object 29 or the elongated rod 20. Additionally, the integral mechanical attachment 28 may function without the any fasteners or attachment mechanisms, such as screws or bolts.

A connection between the spring element 30 and the elongated rod 20 and/or support 12 may be achieved by a variety of designs or configurations. The connection may be formed from a bonding material, snap-fit connection, press-fit connection, and/or a removable, permanent or semi-permanent fastener between the spring element 30 and the elongated rod 20 and/or support 12. Additionally, the roadway marker 10 may include a bushing 50 between the spring element 30 and the first end 22 of the elongated rod 20. The bushing 50 may compensate for a diametral difference between the inner diameter of the spring element 30 and the outer diameter of the elongated rod 20. The bushing 50 may be attached to the elongated rod 20 in a secured manner, such as, for example, press-fit onto the first end 22 of the elongated rod 20. The bushing 50 may be constructed from a variety of materials, including, but not limited to plastics, metallic compounds and synthetic compositions. In one example, the bushing 50 is constructed from UV-resistant Polyoxymethylene, more commonly known as DELRIN®. As depicted in FIG. 3, the bushing 50 may contact the face 34 of the small-diameter coil 32. Additionally, a bushing 50 may be included as a connection design with other parts of the roadway marker 10. Although a bushing 50 may be used, a connection between the spring element 30 and another structure may not require a bushing 50 to form a connection.

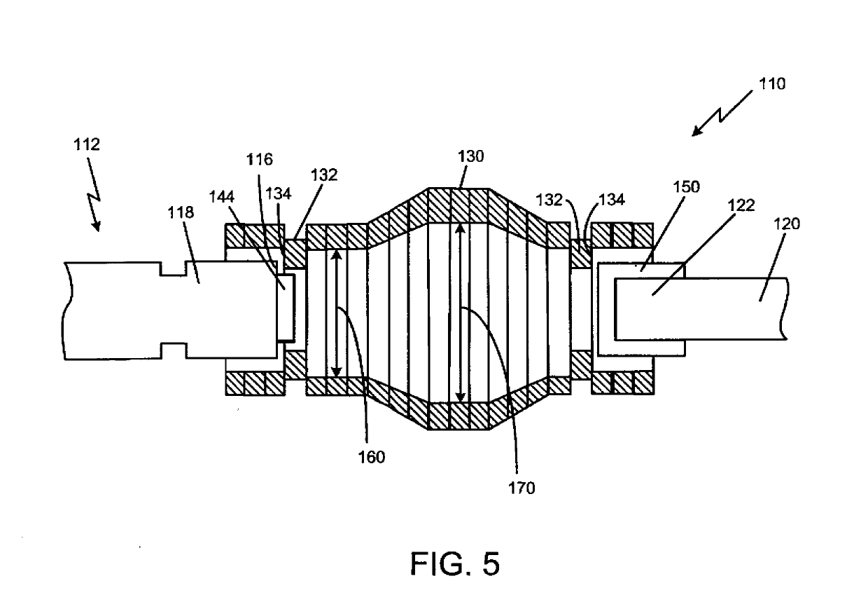

FIG. 5 is a cross-sectional side view of a spring element 130 of the roadway marker 110, in accordance with a second exemplary embodiment of the disclosure. The roadway marker 110 includes a support 112. The support 112 has a first end 114 (not shown), a second end 116 and a middle portion 118 located between the first end 114 and the second end 116. An elongated rod 120, having a first end 122 and a second end (not shown), attaches at the first end 122 to the middle portion 118 of the support 112 with a spring element 130. The support 112 and the elongated rod 120 of the second exemplary embodiment may be similar and/or equivalent to the support 112 and rod 120 of the first exemplary embodiment, in terms of design, size, use, available variations, and any combination thereof.

The spring element 130 of the second exemplary embodiment is characterized as a spring, structure, or combination of structures that has potential energy. For example, the spring element 130 may be a substantially cylindrical barrel spring having an enlarged or varied diameter at the middle portion, and may include other design features or variations, depending on the desired use. The spring element 130 may have an inner diameter 160 and may have one or more reduced inner diameters at the portion of the spring element 130 that contacts the elongated rod 120 and/or the support 112. The inner diameter 160 may be measured between the inner walls of the spring element 130 along a cross-sectional cut taken perpendicular to an axis along the length of the spring element 130. In FIG. 5, the inner diameter 160 is depicted by an arrow identifying the distance between inner walls of the spring element 130 at a point not having an enlarged or reduced diameter. The spring element 130 may have an inner diameter 160 that varies dependent on intended use, environmental conditions, the size of the support 112 and the size of the elongated rod 120. In one example, the inner diameter 160 of the spring element 130 is approximately 1 inch for an elongated rod 120 having a length of approximately 48 inches.

A reduced inner diameter portion 132 of the spring element 130 may be characterized as a portion of the spring element 130 having a small inner diameter with respect to the inner diameter 160 between the inner walls of the spring element 130. The reduced inner diameter portions 132 may be achieved through various designs, structures and configurations. For example, the reduced inner diameter portion 132 may be a small-diameter coil within the spring element 130. The small-diameter coil may protrude towards the inner portion of the spring element 130 thereby creating a face 134 that acts as a structural stop to contact another structure within the spring element 130, such as the elongated rod 120 or the support 112. The reduced inner diameter portion 132 may prevent the elongated rod 120 or support 112 from being inserted too far within the spring coil 130. In one example, the reduced inner diameter portion 132 of the spring element 130 may be located approximately ⅞ inch from the end points of the spring element 130. The reduced inner diameter portion 132 of the spring element 130 may correspond to the diameter of the first end 122 of the elongated rod 120 and/or the second end 116 of the support 112, such that the spring element 130 may be connected to either the support 112 and/or the elongated rod 120, and may include variations in location, size and design.

Similar to FIGS. 3-4, the connection between the spring element 130 and the elongated rod 120 and/or support 112 may be achieved by a variety of designs or configurations. The connection may be formed from a bonding material, snap-fit connection, press-fit connection, and/or a removable, permanent or semi-permanent fastener between the spring element 130 and the elongated rod 120 and/or support 112. Additionally, the roadway marker 110 may include a bushing 150 between the spring element 130 and the first end 122 of the elongated rod 120. The bushing 150 may compensate for a diametral difference between the inner diameter 160 of the spring element 130 and the outer diameter of the elongated rod 20. The bushing 150 may be attached to the elongated rod 120 in a secured manner, such as, for example, press-fit onto the first end 122 of the elongated rod 120. The bushing 150 may be constructed from a variety of materials, including, but not limited to plastics, metallic compounds and synthetic compositions. In one example, the bushing 150 is constructed from UV-resistant Polyoxymethylene, more commonly known as DELRIN®. As depicted in FIG. 5, the bushing 150 may contact the face 134 of the small-diameter coil 132. Additionally, a bushing 150 may be included as a connection design with other parts of the roadway marker 110. Although a bushing 150 may be used, a connection between the spring element 130 and another structure may not require a bushing 150 to form a connection.

The spring element 130 may include a varied diameter 170 at a middle portion that may be enlarged or reduced. The varied diameter 170 maybe characterized as a diameter measurement that is greater than the inner diameter portions 132 of the spring element 130. The varied diameter 170 may be located within a middle portion of the spring element 130, such that it is between the ends and/or between the reduced inner diameters of the spring element 130. The size of the varied diameter 170 may vary depending on design, and may include a size that is minutely larger than the inner diameter 160 to a size that is substantially larger than the inner diameter 160 (such as twice or three times as great). The design of the varied diameter 170 may include any variations, including, but not limited to a smoothly curved shape, a linear shape, an irregular or regular shape, or any combination thereof.

In use, the varied diameter 170 of the spring element 130 may assist with regulating movement of the elongated rod 120 with respect to the support 112. This is suitable for all configurations of the roadway marker 110, including when the support 112, rod 120 and spring element 130 are positioned in a substantially vertical, positioned at an angle to the horizon, or any combination thereof. For example, the varied diameter 170 may allow the elongated rod 120 to deflect in position based on a specific biasing force, and may further regulate recovery of the elongated rod 120 to a substantially upright position. The varied diameter 170 may provide the spring element 130 with a varying spring constant, wherein a change in the size of the varied diameter 170 may correspond to a change in spring constant, required biasing force, time of recovery, or any other characteristic of the roadway marker 110. For example, a varied diameter 170 that is approximately twice the size of the inner diameter 160 may allow the varied elongated rod 120 to recover from a bias position slower, or with greater resistance, than a spring element 130 without a varied diameter 170.

It is noted that the varied diameter 170 may improve use of the roadway marker 110 under varying environmental conditions, use requirements, and/or aesthetic considerations. For example, a varied diameter 170 may allow easier access to the inner portion of the spring element 130 which may be beneficial for ice or snow removal. Furthermore, the measurement of the varied diameter 170 of the spring element 130 that is less than the measurement of the inner diameter 160 may also be included, as would vary by design and intended use.

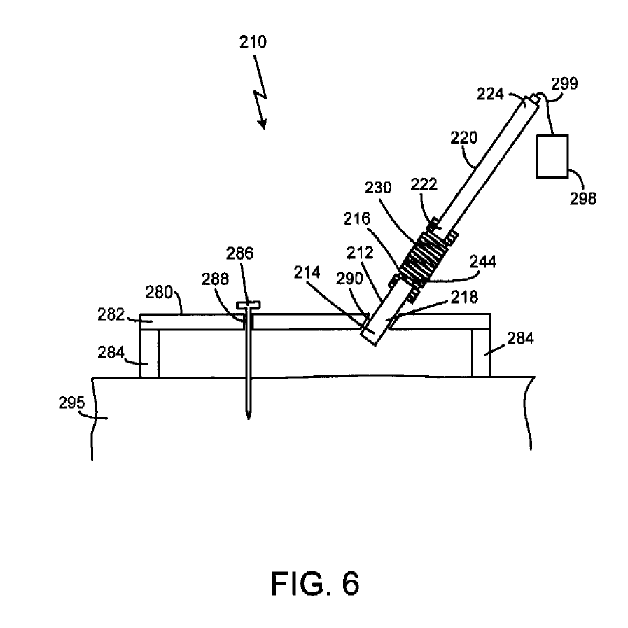

FIG. 6 is a cross-sectional side view of a roadway marker 210, in accordance with a third exemplary embodiment of the disclosure. The roadway marker 210 includes a support 212. The support 212 has a first end 214, a second end 216 and a middle portion 218 located between the first end 214 and the second end 216. An elongated rod 220, having a first end 222 and a second end 224, attaches at the first end 222 to the middle portion 218 of the support 212 with a spring element 230. The first end 214 of the support 212 attaches to a support-supporting platform 280, which may be affixed to the ground 295 or other securing structure.

The support 212 may be constructed from a hard material, such as hardened steel or a hardened metallic compound. The support 212 may also be constructed from any other organic, synthetic or compound material that is hard enough to support the roadway marker 210, such as plastic or wood. The composition of the support 212 may vary depending on the intended use of the roadway marker 210, and may include, for example, compositions that are suitable for environmental or aesthetic variations. The support 212 may also need to withstand the forces associated with securing, such as a driving force or hammering from a tool or device. The first end 214 of the support 212 may include any design, such as a flat or cut-off design, as depicted in FIG. 6. The first end 214 may also include a tapered or sharpened design. Either design of the first end 214 may allow the support 212 to be secured in a stationary position support-supporting platform 280 by force, and/or provide convenience and efficiency in securing the support within the support-supporting platform 280. The support 212 may also include plating on an exterior surface to resist corrosion due to ambient elements, such as resisting rust.

The support 212 is characterized as a rigid shaft having a cylindrical cross-section, but may include a cross-section that is any other shape, such as square or rectangular. The length and diameter (width, if not cylindrical) of the support 212 may be selected to correspond to the intended use of the roadway marker 210, and/or the size of the spring element 230 or the elongated rod 220. For example, the support 212 may be approximately ⅜ of an inch in diameter and 8 inches in length if used with an elongated rod 220 of approximately 48 inches in length. Other lengths and diameters of the support 212 may be used depending on the conditions surrounding the use of the roadway marker 210, which may include ambient temperature, securing conditions or effect on surrounding environment.

FIG. 6 depicts the support 212 having a first end 214, a second end 216 and a middle portion 218. The support 212 may also include a collar groove (not shown) and an installation pad 244. The collar groove may be a groove located around all or a portion of the circumference of the support 212, and may be used to facilitate removal of the support 212 from a secured position, such as from support-supporting platform 280. The collar groove may also be a protruding collar that is used to facilitate removal of the support 212. Removal of the support 212 may be accomplished with an external tool, such as a pry bar using leverage, as discussed previously.

The installation pad 244 is characterized as a structure bearing the force used to install the support 212 in a stationary position. The installation pad 244 may be constructed of a hardened material, such as hardened steel, and may be attached to the second end 216 of the support 212 with a fastener, threaded fastener, adhesive or any other means of creating an attachment. The installation pad 244 may be attached to the end of the support 212 such that it is position within an interior portion of the spring element 230 when the roadway marker 210 is in use. The installation pad 244 may be removably attached. When installing the support 212 into a secured position, such as into a support-supporting platform 280, a hammer may be used to drive the support-supporting 280 into position.

The first end 214, second end 216 and middle portion 218 of the support 212 may be characterized as distinct portions of the support 212. The first end 214 may be characterized as the portion of the support 212 that is proximate to the support-supporting platform 280, when in a secured position. The second end 216 of the elongated rod 220 may be characterized as the portion of the support 212 that is furthest from the first end 214, and used to secure the support 212 in a secured position. The middle portion 218 may be characterized as the portion of the support 212 between the first end 214 and the second end 216.

The elongated rod 220 is characterized as a shaft with a cylindrical cross-section having a length that is substantially greater than a diameter. The diameter of the elongated rod 220 may be any size and may be proportional to the length of the elongated rod 220. For example, an approximate diameter of 0.25 inches may be used with an elongated rod 220 having a length of approximately 48 inches. The elongated rod 220 may also be non-cylindrical in cross-section, such as rectangular or triangular and have a cross-sectional size that varies. The length of the elongated rod 220 may include any size such that it is great enough to mark the edge of a roadway, depending on the desired use. For example, the elongated rod 220 may have a length of 48 inches if the desired use of the roadway marker 210 is in weather conditions where a snowfall is anticipated. Alternatively, a length greater than 48 inches may be required in extreme winter conditions, due to extensive snowfall, or with use in a farming setting, such as with marking the roadway proximate to a field having a crop that grows tall. A length smaller than 48 inches may also be used in other settings, such as in climates where some, but not a substantial amount of snowfall is anticipated.

The elongated rod 220 may include other features such as a colored exterior to enhance visibility of the roadway marker 210. For example, PMS color DS 18-1 C1, generally designated as orange, may be used if the roadway marker 210 is used in a setting involving snow or other winter conditions. Any additional colors, such as yellow, fluorescent green, or combination of colors, such as stripes or contrasting designs, that may enhance visibility may be used and are considered within the scope of the present disclosure. Additionally, the elongated rod 220 may include an exterior, or a portion of an exterior that comprises a reflective material to further enhance visibility of the roadway marker 210. Although reflective material may be used under any conditions, it may be specifically beneficial when the roadway marker 210 is used in conditions with low lighting, such as at night.

The elongated rod 220 may further include an object 298 located proximate to the second end 224 of the elongated rod 220. For example, the object 298 may include an ornamental flag, a decorative element, a dangled reflective element, or a cautionary symbol. The object 298 may also include a star shape, a dangling piece of reflective material, or a flashing light that is attached to the second end 224. Additionally, the structure or object located proximate to the second end 224 of the elongated rod 220 may include printed material, such as cardboard structure or object having an image or text printed thereon. The structure of object 298 may be permanently, semi-permanently or removably attached to the elongated rod 220 by any means commonly known to those in the art, including with rope, string, wire, glue, hook and loop fasteners, bonding agents and snap connector. In one example, a flag constructed from fabric may include a loop portion capable of receiving the second end 224 of the elongated rod 220. The object 298 may be reflective and/or easily visible at various angles and up to 360 degrees such that it is visually noticeable in any position in virtually all conditions. In another example, the structure or object 298 may have an integral mechanical attachment, wherein the structure or object 298 is removably affixed to the elongated rod 220. In accordance with this design, the integral mechanical attachment is not a separate element or structure, but rather an integral part of either the structure or object 298 or the elongated rod 220. Additionally, the integral mechanical attachment may not require any fasteners or attachment mechanisms, such as screws or bolts.

In one of many alternative arrangements, a cap may be affixed to the second end 224 of the elongated rod 220. The cap may restrain an object 298 or it may be used to seal the elongated rod 220. The cap may be constructed from vinyl, rubber, plastic or any other material, may be UV resistant, and may have any color or reflective coating. Additionally, the cap may be permanently, semi-permanently or removably affixed to the elongated rod 220, which may be accomplished by bonding, gluing, fastening, or press or friction fitting the cap to the elongated rod 220. The cap may be secured such that is would remain affixed to the elongated rod 220 under normal operating conditions associated with the roadway marker 210.

The spring element 230 is characterized as a substantially cylindrical barrel spring, antenna spring or coiled spring. The spring element 230 may be constructed from stainless steel wire, such as the 300 series alloy, or any other metal, metallic compound, or synthetic material, that is capable of being formed into a spring structure. The spring element 230 may include a size and shape that is proportional to the elongated rod 220 and the support 212, and may also include further design characteristics depending on the intended use. In one example, the spring element 230 is constructed from 0.110-inch diameter wire. The spring element 230 may include a weather-protection coating, such as galvanization or rubber.

FIG. 6 depicts the spring element 230, in accordance with the third exemplary embodiment. The spring element 230 is substantially similar to the spring elements 30 and 130 of the first and second exemplary embodiments, respectively. The spring element 230 is characterized as a spring or other structure, or combination of structures that has potential energy. For example, the spring element 230 may be a substantially cylindrical barrel spring, as is depicted in FIG. 6. The spring element 230 may also be a barrel spring with an enlarged diameter in a middle portion, and may include design features or variations, depending on the desired use within the roadway marker 210.

The spring element 230 may have an inner diameter and may have one or more reduced inner diameters at the portion of the spring element 230 that contacts the elongated rod 220 and/or the support 212. The inner diameter may be measured between the inner walls of the spring element 230 along a cross-sectional cut taken perpendicular to an axis along the length of the spring element 230. The spring element 230 may have an inner diameter that varies dependent on intended use, environmental conditions, the size of the support 212 and the size of the elongated rod 220. In one example, the inner diameter of the spring element 230 is approximately 1 inch for an elongated rod 220 having a length of approximately 48 inches. The reduced inner diameter of the spring element 230 may be characterized as a portion of the spring element 230 having a small inner diameter with respect to the inner diameter between the inner walls of the spring element 230. The reduced inner may be achieved through various designs, structures and configurations, as discussed with respect to the first and second exemplary embodiments.

A connection between the spring element 230 and the elongated rod 220 and/or support 212 may be achieved by a variety of designs or configurations. For example, the connection may be formed from a bonding material, snap-fit connection, press-fit connection, and/or a removable, permanent or semi-permanent fastener. Additionally, the roadway marker 210 may include a bushing (not shown) between the spring element 230 and the first end 222 of the elongated rod 220. The bushing may compensate for a diametral difference between the inner diameter of the spring element 230 and the outer diameter of the elongated rod 220. The bushing may be attached to the elongated rod 220 in a secured manner, such as, for example, press-fit onto the first end 222 of the elongated rod 220. The bushing may be constructed from a variety of materials, including, but not limited to plastics, metallic compounds and synthetic compositions. In one example, the bushing is constructed from UV-resistant Polyoxymethylene, more commonly known as DELRIN®.

The support-supporting platform 280 receives the first end 214 of the support 212. The support-supporting platform 280 includes a plateau 282 supported by one or more legs 284. The support-supporting platform 280 may be affixed to the ground 295 with one or more securing pin 286 which may be positioned within a securing hole 288 located within the plateau 282. The support-supporting platform 280 may also include one or more protrusions (not shown) that may be driven into the ground 295. The first end 214 of the support 212 may removably secured within a support hole 290, which may be designed to secure the support 212 at an angle with respect to a horizon. As illustrated in FIG. 6, the horizon may be a reference that is parallel to the planar surface of the top of the ground 295 or a planar surface of the plateau 282.

The angle between the horizon and the axis of the support 212 may include any angle. In a first example, the support 212 is secured at an angle of approximately 90° to the horizon. In this arrangement, the support 212, spring element 230 and rod 220 are positioned in a substantially vertical configuration. The support 212, spring element 230 and rod 220 may be in a substantially parallel configuration with an axis along the length of the support 212, wherein the spring element 230 and the elongated rod 220 rise above the support 212 and the support-supporting platform 280. In a second example, the support 212 is secured at an angle of approximately 45° to the horizon. In this arrangement, the support 212, rod 220 and the spring element 230 will be positioned such that the second end 224 of the elongated rod 220 will be offset from above the support-supporting platform 280. The support 212, rod 220 and spring element 230 may remain substantially parallel, but may experience deflections due to external forces, such as gravity that may make the second end 224 of the elongated rod 220 droop slightly, depending on the rigidity and material composition of the elongated rod 220 and the spring element 230. Accordingly, the object 298 connected to the second end 224 of the elongated rod 220 may protrude away from the support-supporting platform 280 thereby protecting the support 212 from roadway traffic.

In either of the first or second examples, or any alternative arrangement, the spring element 230 allows the elongated rod 220 to flex with contact from a roadway vehicle, avoiding damage and/or dislodging of the support-supporting platform 280 from the ground 295 or the support 212 from the support hole 290 within the support-supporting platform 280. Additionally, the object 298 may be connected to the second end 224 of the elongated rod 220 with a flexible connecting element 299 allowing the object 298 to swing when struck by a roadway vehicle and diminish force applied to the elongated rod 220.

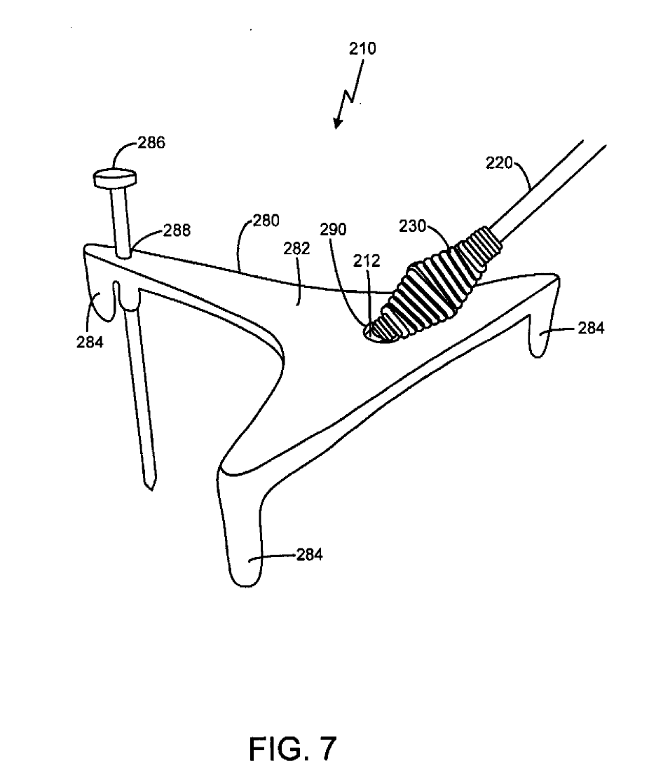

FIG. 7 is a plan view of the roadway marker 210, in accordance with the third exemplary embodiment of the disclosure. As depicted, the roadway marker 210 includes a support-supporting platform 280 having three legs 284 supporting the plateau 282. The plateau 282 is depicted having a T-shape, but may have a design that includes any shape or structure. Likewise, any number of legs 284 may be included to support the plateau 282. An elongated rod 220 is connected to a support 212 with a spring element 230, which is depicted as a barrel spring with an enlarged diameter in a middle portion. The support 212 is connected to the support-supporting platform 280 through the support hole 290 within the plateau 282. The support hole 290 is situated to secure the support 212 at an angle of approximately 30° to the horizon, positioning the elongated rod 220 to be offset from the support-supporting platform 280.

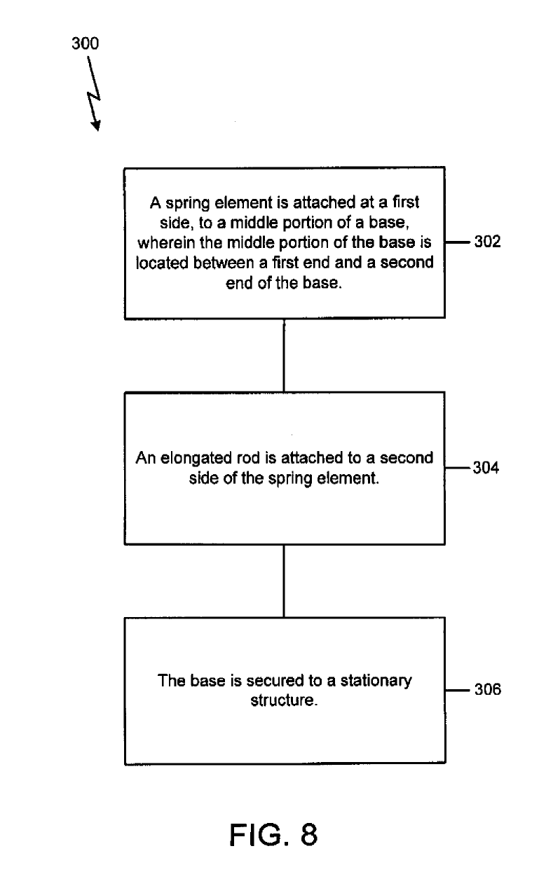

FIG. 8 is an illustration of a flowchart 300 illustrating a method 300 of securing a roadway marker, in accordance with a fourth exemplary embodiment of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As shown by block 302 a spring element 30 is attached at a first side, to a middle portion 18 of a support 12, wherein the middle portion 18 of the support 12 is located between a first end 14 and a second end 16 of the support 12. At block 304 an elongated rod 20 is attached to a second side of the spring element 30. At block 306, the support 12 is secured to a stationary structure. Not illustrated in FIG. 8, but considered within the scope of the present disclosure, the stationary structure may be a ground surface and/or a ground-securing unit situated to receive the support at an angle, wherein the angle is measured between an elongated axis of the support is and a horizon.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment of the disclosure without departing substantially from the spirit and principles of the disclosure. All such modifications and variations are intended to be included herein within the scope of the present disclosure and protected by the following claims.

What is claimed is:

1. A marking device, comprising:
a support having a first end engaged with a ground surface, and a second end positioned away from the ground surface;
a force transfer structure, connected to the second end of the support, wherein the force transfer structure has a diameter less than a diameter of a middle portion of the support;
a cylindrical biasing mechanism attached to the middle portion of the support, wherein the cylindrical biasing mechanism has a first end, a second end and a middle portion, wherein the middle portion has a diameter that exceeds a diameter of the first end and the second end; and
an elongated rod, attached to the second end of the biasing mechanism at a first end.

2. The marking device of claim 1 further comprising a collar groove located in the middle portion of the support.

3. The marking device of claim 1 further comprising an object attached to the second end of the elongated rod.

4. A marking device for marking a location, comprising:
a support positioned to be engaged with a ground surface at a first end, wherein a second end of the support is positioned to face away from the ground surface;
a collar structure positioned proximate to a middle portion of the support, the middle portion positioned between the first end and the second end;
a rebounding spring element attached to the middle portion of the support;
an elongated rod, attached to the spring element at a first end of the elongated rod; and
an identifying marker positioned at a second end of the elongated rod.

5. The marking device of claim 4, wherein the spring element is characterized as a cylindrical spring having a first end, a second end and a middle portion, wherein a diameter of the middle portion of the cylindrical spring exceeds a diameter of both the first end and the second end of the cylindrical spring.

6. The marking device of claim 4, wherein the collar structure further comprises a collar groove having a diameter that is less than a diameter of the middle portion of the support.

7. The marking device of claim 4, wherein the support further comprises a driving structure formed in the second end of the support.

8. The marking device of claim 4, wherein the support is secured in a soil surface.

9. The marking device of claim 4, wherein the first end of the support is removably affixed to a ground-securing unit.

10. The marking device of claim 9, wherein the first end of support is removably affixed to a ground-securing unit at an angle less than 90°.

11. The marking device of claim 4, wherein the elongated rod comprises reflective material.

12. The marking device of claim 4, wherein the support is comprised of rust resistant materials.

13. The marking device of claim 4, wherein an object is connected to a second end of the elongated rod.

14. The marking device of claim 13, wherein the object connected to a second end of the elongated rod is removably affixed to the elongated rod with an integral mechanical attachment.

15. The marking device of claim 13, wherein at least a portion of the object includes a printed material.

16. The marking device of claim 4, wherein the spring element is removably attached to the elongated rod.

17. The marking device of claim 4, wherein the spring element is removably attached to the middle portion of the support.

18. A method of securing a roadway marking device comprising:
attaching a spring element, at a first side, to a middle portion of a support, wherein the middle portion of the support is located between a first end and a second end of the support;
attaching an elongated rod to a second side of the spring element; and
securing the support to a stationary structure.

19. The method of securing a roadway marking device of claim 18, wherein the stationary structure is a ground surface.

20. The method of securing a roadway marking device of claim 18, wherein the stationary structure is a ground-securing unit situated to receive the support at an angle, wherein the angle is measured between an elongated axis of the support is and a horizon.
